(19) United States
(12) Patent Application Publication
(10) Pub. No.: US 2015/0111453 A1
(43) Pub. Date: Apr. 23, 2015

(54) WET PU + GF HEADLINER SUBSTRATE WITH ACOUSTIC FUNCTION

(71) Applicant: GM Global Technology Operations LLC, Detroit, MI (US)

(72) Inventors: Carlos Augusto Garcez da Silva, Sao Pulo (BR); Marcio Calcada, Indaiatuba (BR); Luiz C. Massarelli, Sao Caetano do Sul (BR); Luis Fernando Braga, Diadema (BR)

(73) Assignee: GM Global Technology Operations LLC, Detroit, MI (US)

(21) Appl. No.: 14/060,151

(22) Filed: Oct. 22, 2013

(51) Int. Cl. B32B 5/02; B32B 27/08; B32B 17/06; B32B 37/24; B32B 5/24

(52) U.S. Cl. CPC B32B 5/024; B32B 37/24; B32B 5/022; B32B 5/245; B32B 17/064; B32B 27/08; B32B 2307/102; B32B 2250/05; B32B 2305/026; B32B 2305/022; B32B 2305/18; B32B 2262/101; B32B 2266/06
USPC 442/223; 156/307.1

(57) ABSTRACT

One variation includes a composite material and method of manufacture thereof wherein a composite material may be fabricated from a finishing, a porous film, a weave, a foam, and a bonding agent, wherein the finishing at least partially overlays the porous film, wherein the porous film at least partially overlays the weave, wherein the weave at least partially overlays the foam, and wherein the porous film comprises high density polyethylene.

### TECHNICAL FIELD

The field to which the disclosure generally relates to includes composite materials, including, but not limited to composite materials used in vehicle frames and structures, such as, but not limited to frames or structures included in passenger vehicles, motor cycles, bicycles, rough terrain vehicles, watercraft, trains, aircraft, or spacecraft, as well as in other sound dampening applications such as insulation in electronic, civil engineering, and mechanical engineering applications.

### BACKGROUND

Currently, some composite materials may be formed from low density polyethylene to provide sound absorption in some applications.

### SUMMARY OF ILLUSTRATIVE VARIATIONS

A number of variations may include a product comprising a composite material comprising a finishing, a porous film, a weave, a foam, and a bonding agent, wherein the finishing at least partially overlays the porous film, wherein the porous film at least partially overlays the weave, wherein the weave at least partially overlays the foam, and wherein the porous film comprises high density polyethylene.

A number of variations may include a method comprising: providing a plurality of components comprising finishing, a film, a weave comprising high density polyethylene, a foam, a bonding agent, and a mold cavity, positioning the finishing in the mold cavity, positioning the bonding agent in contact with the finishing, positioning the film over the finishing, positioning the weave over the film, positioning the foam over the weave, wherein at least one of the plurality of components comprises a curable material, and curing the curable material to form a composite material comprising the plurality of components.

A number of variations may include a method comprising: providing a plurality of components comprising a first finishing, a first film comprising high density polyethylene, a first weave, a foam, a first bonding agent, a second finishing, a second film comprising high density polyethylene, a second weave, a second bonding agent and a mold cavity, positioning the first finishing in the mold cavity, positioning the first bonding agent in contact with the first finishing, positioning the first porous film over the first finishing, positioning the first weave over the first film, positioning the foam over the first weave, positioning the second weave over the foam, positioning the second film over the second weave, positioning the second bonding agent in contact with the second finishing, positioning the second bonding agent and the second finishing over the second film, wherein at least one of the plurality of components comprises a curable material, and curing the curable material to form a composite material comprising the plurality of components.

Other illustrative variations within the scope of the invention will become apparent from the detailed description provided hereinafter. It should be understood that the detailed description and specific examples, while disclosing optional variations within the scope of the invention, are intended for purposes of illustration only and are not intended to limit the scope of the invention.

### BRIEF DESCRIPTION OF THE DRAWINGS

Select illustrative examples of variations will become more fully understood from the detailed description and the accompanying drawings, wherein:

FIG. 1 illustrates a cross-sectional view of a composite material according to a number of variations.

FIG. 2 illustrates a cross-sectional view of a composite material according to a number of variations.

FIG. 3 is a comparison line chart of random incidence sound absorption coefficient from 400 Hz to 10 kHz in ⅓ octave frequency band of one variation of a composite material within the scope of the invention and two variations of prior art composite materials.

FIG. 4 is a comparison line chart of Articulation Index % for the vehicle in 3^{rd} gear Wide Open Throttle Sweep from 1000 to 6000 engine RPM in the first row (right front passenger's side head position) of one variation of a composite material within the scope of the invention and one variation of a prior art composite material baseline.

FIG. 5 is a comparison line chart of Articulation Index % for the vehicle in 3^{rd} gear Wide Open Throttle Sweep from 1000 to 6000 engine RPM in the second row (left rear passenger's side head position) of one variation of a composite material within the scope of the invention and one variation of a prior art composite material baseline.

FIG. 6 is a comparison line chart of Articulation Index % for the vehicle in 3^{rd} gear Wide Open Throttle Sweep from 1000 to 6000 engine RPM in the third row (third row passenger's side head position) of one variation of a composite material within the scope of the invention and one variation of a prior art composite material baseline.

### DETAILED DESCRIPTION OF ILLUSTRATIVE VARIATIONS OF THE INVENTION

The following description of the variations is merely illustrative in nature and is in no way intended to limit the scope of the invention, its application, or uses.

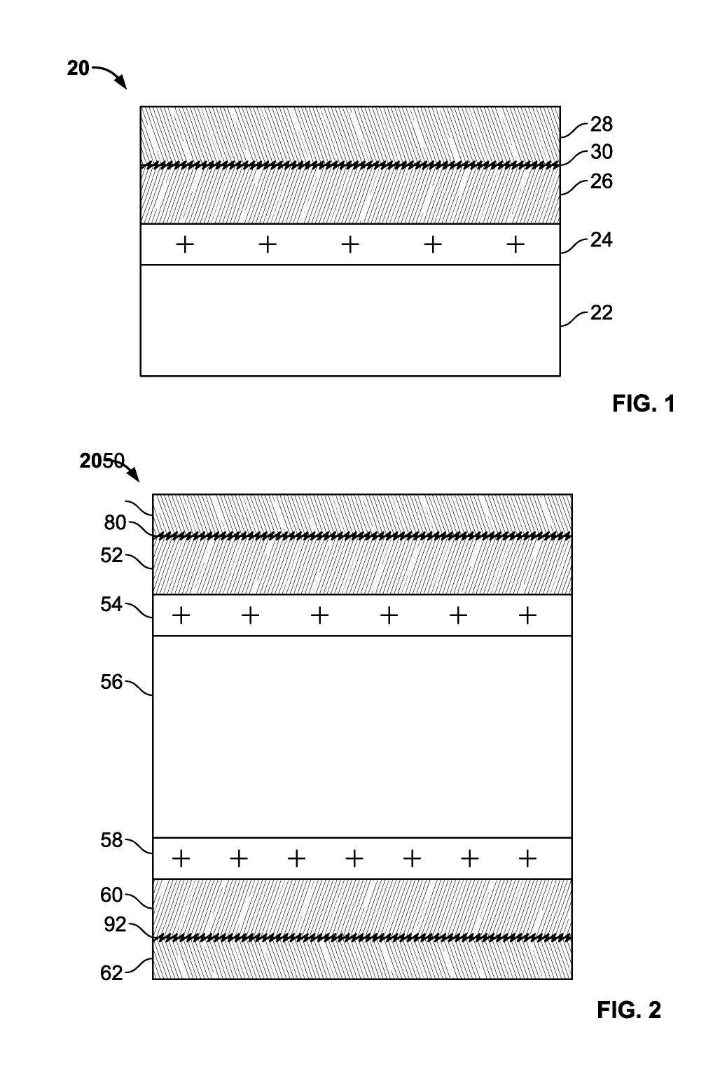

FIG. 1 illustrates a composite material 20 according to a number of variations. In a number of variations the composite material 20 may be useful in components included in passenger vehicles, motor cycles, bicycles, rough terrain vehicles, watercraft, trains, aircraft, or spacecraft, as well as in other sound dampening applications such as insulation in electronic, civil engineering, and mechanical engineering applications. In a number of variations the composite material 20 may provide lower air flow resistance and higher sound absorption coefficients over other composite materials without increasing mass and parts. In one variation, the composite material 20 may include a plurality of layers. In one variation, the composite material 20 may include a foam 22. The foam 22 may be an open-cell foam or a closed-cell foam. The foam may be a ballistic foam, a nanofoam, a syntactic foam, an integral skin foam, a solid foam, a liquid foam, or may be another type. The foam may be low-expansion, high-expansion, alcohol-resistant or may be another type. The foam may be low-density or high-density. In a number of variations a low density foam may be used to allow greater penetration of sound waves and minimize reflection at the surface of the foam. Sound absorption increases with increasing thickness and area of the foam. The foam may include an organic polymer, a ceramic, or a metal. The foam may be made from a foam composition which may include polyurethane, polyester, alumina, beryllia, ceria, zirconia, silicide, nitride, boride, carbide, a surfactant, an organic solvent, a protein foam (including, but not limited to, regular protein foam, fluoroprotein foam, film-forming fluoroprotein, alcohol-resistant fluoroprotein foam, or alcohol-resistant film-forming fluoroprotein), high density, Evlon, rubber, Supreem, Rebond, Memory Foam, Polyether, Polyethylene, Crosslinked Polyethylene, Latex, Neoprene, Ethafoam, Polystyrene, Styrofoam™, Polyfoam, Nimbus, IMPAXX™ or may include another type. The foam 22 may be flexible or rigid. The foam 22 may contain a plurality of cells of different size and shape. The foam may contain cells of any shape including, but not limited to, polyhedron, spheres, or may be another type.

In one variation, the foam 22 may be made from a foam composition, which may contain polyurethane. Polyurethanes may be produced by a reaction of an isocyanate containing two or more isocyanate groups per molecule with a polyol containing on average two or more hydroxy groups per molecule in the presence of a catalyst. The foam 22 polyurethane may be soft and elastic or tough and rigid depending on the amount of crosslinking. The isocyanate may include at least one of aromatic isocyanates, diphenylmethane diisocyanate (MDI) or toluene diisocyanate (TDI), aliphatic isocyanates, such as hexamethylene diisocyanate (HDI) or isophorone diisocyanate (IPDI). Polyols used may include polyether polyols or polyester polyols, polypropylene oxide, graft polyols, polycarbonate polyols, polycaprolactone polyols, polybutadiene polyols, polysulfide, natural oil polyols, FEVE fluorinated polyols, or may be another type. The polyols may include dipropylene glycol, glycerine, sorbitol, sucrose, sorbitol, toluenediamine, or Mannich bases. The foam 22 may contain chain extenders. The chain extenders may include at least one of ethylene glycol, 1,4-butanediol (1,4-BDO or BDO), 1,6-hexanediol, cyclohexane dimethanol and hydroquinone bis(2-hydroxyethyl) ether (HQEE), or may be another type. The foam composition may contain a surfactant. The surfactant may contain polydimethylsiloxane-polyoxyalkylene block copolymers, silicone oils, nonylphenol ethoxylates, or may be another type. The foam 22 may be produced by mixing the components in different ratios at different times depending on the foam 22 application. The foam 22 may be preimpregnated, coated, or otherwise in contact with a bonding agent 30.

In one variation, the foam 22 may contain a polyester basis. The polyester basis may have a density of about 18 kg/m³. The foam 22 may be a conventional flexible polyurethane foam under the specifications provided below in Table 1.

| Property | Value |
|---|---|
| Density(kg/m³), min | 16.2 |
| Tensile Strength (kPa), min | 70 |
| Elongation (%), min | 120 |
| Tear resistance (N/m), min | 400 |
| Resilience (%) | 30-35 |
| Permanent deformation under 90% (%), max | 12 |
| Load support, 65% (N), min | 140 |
| Factor sag, min | 2.0 |
| Ashes (%), max | 0.5 |
| Thickness loss (%), max | 5 |
| Support loss, 25 (%), max | 30 |
| Indentation force under 40% (N), min | 80 |
| Comfort factor, min | 2.0 |
| Dynamic fatigue - Thickness loss (%), max | 8 |
| Dynamic fatigue - Loss of FI, 40% (%), max | 32 |

The foam cell may be stretched to a range of 10 to 20 cells per cm to vary the hardness of the foam 22. Air may be injected into the foam for varying the hardness of the foam. In one variation, a silicone surfactant may be used during manufacturing to decrease cell size and increase the number of cells. The foam may have any dimension in any direction tailored to fit its desired application.

In one variation, the foam composition may include diphenylmethane diisocyanate (MDI). The MDI may have a viscosity of 60-80 mPa. The MDI may have a 31.5% content of NCO. In one variation, the MDI may be manufactured through the nitration of benzene forming nitrobenzene, which may then be hydrogenated to form aniline. The aniline forms a condensation with formaldehyde catalyzed by hydrochloric acid to form a mixture of diphenylmethane dianilinas (MDA) containing different isomers with two or more aromatic rings. The MDI may be reacted with a number of isocyanate groups in a polyisocyanate compound. Polymeric MDI may comprise isomers 4,4′ diphenylmethane diisocyanate, 2,4″diphenylmethane diisocyanate, and 2,2′ diphenylmethane diisocyanate, as well as condensation products with more than two aromatic rings. In another variation pure MDI may be reacted with a diol in a proportion of 2/1. A diisocyanate liquid product, with a functionality equal to 2, may be mixed with pure MDL resulting in a modified MDI liquid. In another variation, the isocyanate may be converted to carbodiimide, which reacts with excess isocyanate to form uretonimine. A diisocyanate liquid with a functionality equal to 3 may be achieved and this compound may be mixed with pure MDI which results in carbodiimide modified MDI, which has an average functionality of approximately 2.2. and a melting point of below 20° C.

The foam 22 may also contain a catalyst. Some compounds that may be used as a catalyst are shown in Table 2 below. The catalyst may contain a tertiary amine.

| Catalyst | Characteristics/Application |
|---|---|
| 1. N.N-dimethyl ethanolamine | Reactive expansion catalyst, low cost |
| (DMEA) | liquid, low odor, used in flexible and rigid |
| (CH₃)₂NCH₂CH₂OH | foams. |
| 2. bis-(dimethylaminoethyl)ether | Excellent blowing catalyst, low odor liquid |
| (BDMAEEE) | used in flexible foams and molded block |
| (CH₃)₂NCH₂CH₂OCH₂CH₂N(CH₃)₂ | |
| 3. bis-(dimethylaminoethyl)ether | Expansion reactive amine used in molded |
| ethoxylate | flexible foams |
| (BDMAEEE) | |
| (CH₃)₂NCH₂CH₂OCH₂CH₂N(CH₃)CH₂CH₂OH | |
| 4. (2-dimethylamino-ethoxy)ethanol | Expansion reactive amine used in low |
| (DMAEE) | density flexible foams |
| (CH₃)₂NCH₂CH₂₀CH₂CH₂OH | |
| 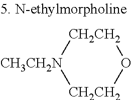 | Catalyst for healing skin. Characteristic odor of volatile liquid with low viscosity used in flexible molded foams. |
| 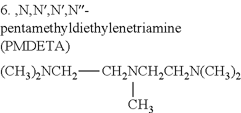 | Expansion catalyst used in flexible foams, semi-rigid and rigid. Due to the preference for reaction isocyanate/water provides excellent fluidity at the beginning of the reaction. |
| 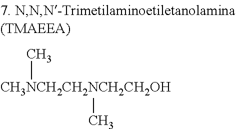 | Expansion reactive catalyst employed in high resilience flexible foams and microcellular. |

N,N,N′,N′,N″-penta methyl diethylene triamine (PMDETA) may also be capable of chelating the water and also acts as a catalyst for expansion.

| | | Gelling | Expansion | Expansion/ |
|---|---|---|---|---|
| | | activity | activity | gelling ratio |
| Name | Acronym | (k₁) (x) | (k₂) (x) | (×10⁻¹) |
| N,N-dimethyl | DMEA | 2.91 | 0.36 | 1.23 |
| amino ethanol | | | | |

In one variation, a delayed action catalyst may be used. A delayed action catalyst may improve the flow of reactant mass and allow for better mold fitting and faster curing. In one variation, a retarded blowing catalyst may be used when the bubble growth is large. In one variation, a retarded gelation catalyst may be used when the polymerization rate and viscosity of the foam is high. The catalyst may include tertiary amines blocked with carboxylic acid to react to form salts with no catalytic activity. In one variation, the foam 22 may include a low density polyurethane foam with a mass concentration of 18 g/l. The foam 22 may include a polyisocyanate solution with two active hydrogens compared with the isocyanate group reactive tertiary amides having a density of 320 g/m².

Still referring to FIG. 1, the composite material 20 may contain a weave 24. In one variation, the weave 24 may comprise a plurality of fibers. The fibers may be textile, natural or synthetic or may be another type. The fibers in the weave 24 may include animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomax), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), basalt, or may be another type. The weave 24 may include a metal including at least one of stainless steel, titanium, steel, cast iron, alloy steel, stainless steel, platinum, palladium, aluminum, copper, nickel, iron, lead, tin, cobalt, bronze, or may be another type. The weave 24 may contain combinations of the above in varying concentrations with weight percentages of individual components at anywhere from 0-100% and the components may be intermixed. The weave 24 may be formed by sheets, continuous mats, or as continuous filaments. The weave 24 may be manufactured or woven through weaving, knitting, braiding, stitching, plain weaving, satin weaving, or may be manufactured in another way. The weave 24 can be manufactured in a two dimensional or three dimensional orientation. The weave 24 may be formed using a hand lay-up operation, an extrusion operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. The weave 24 may include short-fiber reinforced materials or continuous fiber-reinforced materials or may include another type. The weave 24 may have various widths, lengths and/or diameters of fibers as well as in its overall dimensions and may be shaped to fit its desired application. The weave 24 may have a fiber length of between 70 and 100 mm. In one variation, the weave 24 may be formed by strands composed of continuous glass filaments. The glass filaments may be wrapped in a single cable. In one variation the strands of the glass filaments may be bonded by a chemical surface treatment. The strands may be wound in a cylindrical coil without a core. The weave 24 may be a roving processed on a rolling machine. The weave 24 may be a roving ME 3050. The weave 24 may be preimpregnated, coated, or otherwise in contact with a bonding agent 30. In one variation the content of glass in the bonding agent without load may be between 30 and 35% by weight. In one variation if the rolling resin contains load, the content of glass in the laminates may be between 15 and 20% by weight. The bonding agent 30 may have mechanical properties as shown in Table 3 below.

| | Mpa (dry) |
|---|---|
| Tensile Strength | 76-96 |
| Tensile Modulus | 7500-8900 |
| Flexural Strength | 165-193 |
| Flexural Modulus | 7500-8900 |
| | Mpa (wet) |
| Tensile Strength | 69-83 |
| Tensile Modulus | 5200-6200 |
| Flexural Strength | 130-140 |
| Flexural Modulus | 5300-6200 |

Still referring to FIG. 1, in one variation the composite material 20 may include a film 26. The film 26 may be a liquid or a solid. The film 26 may include a plurality of fibers. The film 26 may include a polymer. The polymer may be high density or low density. The polymer may include, but is not limited to, lyocell rayon, modal rayon, rayon, glass, silica, carbon, basalt, metallic, acrylic, aramid, microfiber, modacrylic, nylon, olefin, polyester, spandex, vinylon, vinyon, polyvinyl chloride (PVC), bioplastic, zylon, saran, rubber, vulcanized rubber, urea-formaldehyde, melamine, polyimide, cyanate ester, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), acrylic (PMMA), polyethylene (PE), PEO, PET, polypropylene (PP), PEN, PPS, Teflon (PTFE), polystyrene (PS), or may be another type. The film 26 may contain combinations of the above in varying concentrations with weight percentages of individual components at anywhere from 0-100% and the components may be intermixed. The film 26 may be formed using a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, continuous filament, extrusion, continuous extrusion, cast, calendar rolls, skiving, solution deposition, lamination, physical vapor deposition, or may be formed another way. The film 26 may have various widths, lengths, and/or diameters of fibers as well as in its overall dimensions and may be shaped to fit its desired application. The film 26 may be preimpregnated, coated, or otherwise in contact with a bonding agent 30. In one variation, the film 26 may be a high density polyethylene film. In one variation, the film 26 may contain a high content of ethylene vinyl acetate. In one variation, the film 26 may have a density of 40 g/m². In one variation, the film may have a thickness of 0.45 μm. The film 26 may be porous. In one variation, the film 26 may have the characteristics as shown in Table 5 below.

| | Specification |
|---|---|
| Characteristic | |
| Weight (g/m²) | 35 ± 5 |
| Thickness (mm) | 0.040 ± 0.004 |
| Width (mm) | 1500 ± 10 |
| Softening point (° C.) | |
| Film Elongation at Break (%) | 90 to 120 |
| DM/MD | ≧100 |
| DT/TD | ≧100 |
| Tensile strength (kgf/cm) | |
| DM/MD | ≧0.5 |
| DT/TD | ≧0.3 |
| Color | No color |
| Corona treatment | from 38 to 42 |

In one variation the film 26 may be a high density polyethylene film. In one variation the film 26 may contain a high content of ethylene vinyl acetate. In one variation, the film 26 may have a density of 40 g/m². In one variation, the film may have a thickness of 0.25 μm. The film may be porous. In one variation, the film 26 may have the characteristics as shown in Table 6 below.

| | Specification |
|---|---|
| Caracteristic | |
| Weight (g/m²) | 25 ± 5 |
| Thickness (mm) | 0.025 ± 0.002 |
| Width (mm) | 1500 ± 10 |
| Softening point (° C.) | |
| Film Elongation at Break (%) | 115 to 125 |
| DM/MD | ≧60 |
| DT/TD | ≧60 |
| Tensile strength (kgf/cm) | |
| DM/MD | ≧0.20 |
| DT/TD | ≧0.15 |
| Color | No color |
| Corona treatment | from 38 to 42 |

Still referring to FIG. 1, in one variation the composite material 20 may include a finishing 28. The finishing may be woven or non-woven. The finishing may be a fabric. In one variation, the finishing 28 may comprise a plurality of fibers. The fibers may be textile, natural or synthetic or may be another type. The fibers in the finishing 28 may include animal, vegetable, or mineral fibers including, but not limited to, alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomax), microfiber, modacrylic, nylon, olefin, polyester, polyurethane, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), basalt, aluminum, felt, polyethylene (PE), PEO, PET, polypropylene (PP), PEN, PPS, Teflon (PTFE), polystyrene (PS), poly vinyl chloride (PVC) or may be another type. The finishing 28 may include a metal including at least one of stainless steel, titanium, steel, cast iron, alloy steel, stainless steel, platinum, palladium, aluminum, copper, nickel, iron, lead, tin, cobalt, bronze, or may be another type. The finishing 28 may contain combinations of the above in varying concentrations with weight percentages of individual components at anywhere from 0-100% and the components may be intermixed. The finishing 28 may be formed by sheets, continuous mats, or as continuous filaments. The finishing 28 may be manufactured or woven through weaving, knitting, braiding, a tear process, a needle process, stitching, plain weaving, satin weaving, or may be manufactured in another way. The finishing 28 can be manufactured in a two dimensional or three dimensional orientation. The finishing 28 may be formed using a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, continuous filament, or may be formed another way. The finishing 28 may include short-fiber reinforced materials or continuous fiber-reinforced materials or may include another type. The finishing 28 may have various widths, lengths and/or diameters of fibers as well as in its overall dimensions and may be shaped to fit its desired application. In one variation, the finishing may be 100% polyester made using a tear or needled process. In one variation, the finishing 28 may have a mass dispersion from 150 g/m to 250 g/m coupled or not to the polyester foam. In one variation the finishing 28 may have longitudinal and traversal stretching from 150 to 180%. In one variation, the finishing may have a density of 45 g/m². The finishing 28 may be preimpregnated, coated, or otherwise in contact with a bonding agent 30.

Still referring to FIG. 1, a bonding agent 30 may be held in contact with the foam 22, weave 24, film 26, or finishing 28 or any combination thereof. This contact may result in adherence, binding, or bonding between the foam 22, weave 24, film 26, or finishing 28, or any combination thereof. The bonding agent 30 may include urethane resin, vinylester resin, polyester resin, epoxy resin, phenolic resin, modified phenolic resin, vinyl-bis-phenolic, esther-vinylic, or may be another type. The bonding agent 30 may be reactive or non-reactive.

The composite material 20 may be produced by various fabrication or manufacturing methods. The composite material 20 may be in two or three dimensional orientation. The foam 22, weave 24, film 26, or finishing 28, or any combination may be manufactured or woven through weaving, knitting, braiding, stitching, plain weaving, satin weaving, or may be manufactured another way. In one variation, at least one of a weave, a knit, a braid, a stitch, a plain weave, or a satin weave can be added to the foam 22, weave 24, film 26, or finishing 28, or any combination during manufacture or fabrication. Some examples of orientations of the at least one of a weave, a knit, a braid, a stitch, a plain weave, or a satin weave including, but are not limited to, 90 degree, 45 degree, or 60 degree or may be another degree. In one variation, fibers in the foam 22, weave 24, film 26, finishing 28, or any combination thereof may be bundled prior to manufacture or may be bundled during manufacture. In one variation the foam 22, weave 24, film 26, and finishing 28 may be positioned within a mold cavity, compacted, and cured. In one variation, a finishing 28 may be positioned into a mold cavity. The finishing 28 may be preimpregnated, coated, saturated, positioned in a layer, or otherwise contacted with the bonding agent 30 in one variation. The film 26 may be positioned to at least partially overlay, overlay, partially surround, or fully surround the finishing 28. The film 26 may be preimpregnated, coated, saturated, positioned in a layer, or otherwise contacted with the bonding agent 30 in one variation. The weave 24 may be positioned to at least partially overlay, overlay, partially surround, or fully surround the film 26. The weave 24 may be preimpregnated, coated, saturated, positioned in a layer, or otherwise contacted with the bonding agent 30 in one variation. The foam 22 may be positioned to at least partially overlay, overlay, partially surround, or fully surround the weave 24. The foam 22 may be preimpregnated, coated, saturated, positioned in a layer, or otherwise contacted with the bonding agent 30 in one variation. The mold may be closed and cured to form a cured composite material 20. The orientation of the foam 22, weave 24, film 26, or finishing 28 relative to each other may be adapted to fit the application of the composite material 20 (i.e. any one of these components could be placed in contact with any other component). Other methods may be used to form the composite material 20. These methods include, but are not limited to, hand lay-up operation, a spray lay-up operation, a pultrusion operation, a chopped strand mat, vacuum bag moulding, pressure bag moulding, autoclave moulding, resin transfer moulding, injection moulding, polymeric liquid composite moulding, vacuum assisted resin transfer moulding, bladder moulding, compression moulding, mandrel wrapping, face sheet rolling, wet layup, chopper gun, filament winding, or may be formed another way. The composite material 20 may be formed to sheets in an orientation of the foam 22, weave 24, film 26, or finishing 28, in any combination or layer formation. The composite material 20 may be finished with other methods for a final design. The mold may be tooled to form the desired shape or variation of the composite material 20 for its intended application. A person of skill in the art would recognize these techniques.

In one variation, a first finishing 50 may be positioned into a mold cavity. The first finishing 50 may be preimpregnated, coated, saturated, positioned in a layer, or otherwise contacted with a first bonding agent 80 in one variation. A first film 52 may be positioned to at least partially overlay, overlay, partially surround, or fully surround the first finishing 50. The first film 52 may be preimpregnated, coated, saturated, positioned in a layer, or otherwise contacted with a second bonding agent 82 in one variation. A first weave 54 may be at positioned to at least partially overlay, overlay, partially surround, or fully surround the first film 52. The first weave 54 may be preimpregnated, coated, saturated, positioned in a layer, or otherwise contacted with a third bonding agent 84 in one variation. A foam 56 may be at positioned to at least partially overlay, overlay, partially surround, or fully surround the first weave 54. The foam 56 may be preimpregnated, coated, saturated, positioned in a layer, or otherwise contacted with a fourth bonding agent 86 in one variation. A second weave 58 may be at positioned to at least partially overlay, overlay, partially surround, or fully surround the foam 56. The second weave 58 may be preimpregnated, coated, saturated, positioned in a layer, or otherwise contacted with a fifth bonding agent 88 in one variation. A second film 60 may be at positioned to at least partially overlay, overlay, partially surround, or fully surround the second weave 58. The second film 60 may be preimpregnated, coated, saturated, positioned in a layer, or otherwise contacted with a sixth bonding agent 90 in one variation. A second finishing 62 may be at positioned to at least partially overlay, overlay, partially surround, or fully surround the second film 60. The second finishing 62 may be preimpregnated, coated, saturated, positioned in a layer, or otherwise contacted with a seventh bonding agent 92 in one variation. The mold may be closed and cured to form a cured composite material 20. A variation of the composite material 20 is shown in FIG. 2. The orientation of the first finishing 50, first film 52, first weave 54, foam 56, second weave 58, second film 60, and second finishing 62 relative to each other may be adapted to fit the application of the composite material 20 (i.e. any one of these components could be placed in contact with any other component). The first bonding agent 80, second bonding agent 82, third bonding agent 84, fourth bonding agent 86, fifth bonding agent 88, sixth bonding agent 90, and seventh bonding agent 92 may be of the same concentration and components or may be different from one another in any combination. In one variation, some or all of the first bonding agent 80, second bonding agent 82, third bonding agent 84, fourth bonding agent 86, fifth bonding agent 88, sixth bonding agent 90, and seventh bonding agent 92 may not be necessarily included. Other methods may be used to form the composite material 20. These methods include, but are not limited to, hand lay-up operation, a spray lay-up operation, a pultrusion operation, a chopped strand mat, vacuum bag moulding, pressure bag moulding, autoclave moulding, resin transfer moulding, injection moulding, polymeric liquid composite moulding, vacuum assisted resin transfer moulding, bladder moulding, compression moulding, mandrel wrapping, face sheet rolling, wet layup, chopper gun, filament winding, or may be formed another way. The composite material 20 may be finished with other methods for a final design. The mold may be tooled to form the desired shape or variation of the composite material 20 for its intended application. A person of skill in the art would recognize these techniques.

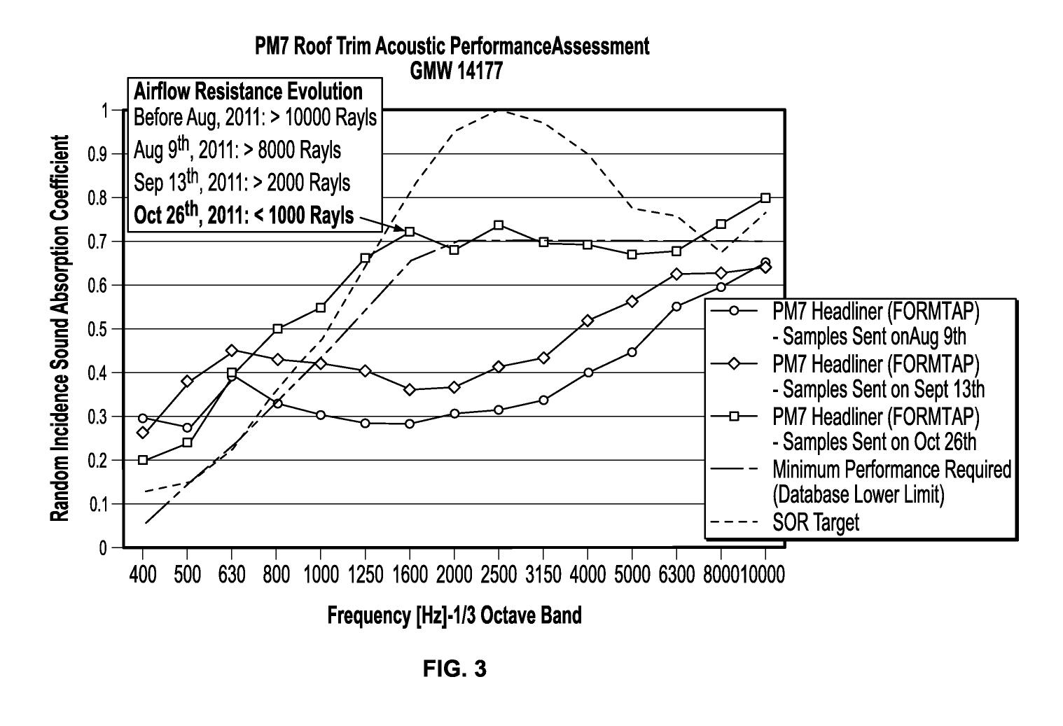

FIG. 3 is a comparison line chart of random incidence sound absorption coefficient from 400 Hz to 10 kHz in ⅓ octave frequency band of a variation of a composite material 20 and two variations of prior art composite materials. Also shown are the minimum performance required for headliners according to certain requirements and target performance line. The PM7 headliner (FORMTAP) composite material 20 may show improved sound absorption without the use of external acoustical treatments. The composite material 20 may be useful for noise control applications.

Airflow resistance of sound absorption materials may be measured using a method according to ISO 9053 or ASTM C522, wherein a sample of a composite material 20 is placed inside a tube and subjected to airflow. Then, the differential pressure drop (ΔP) across the sample is measured for different airflow speeds (v). An average value is taken at a region where ΔP/v is roughly constant (laminar flow condition). Volume flowrate (Q) is the cross sectional area (A) multiplied by the airflow speed (v). Airflow resistance (R) is defined as ΔP/Q [Pa·s/m³]. Specific airflow resistance (r) is defined as ΔP/v [Pa·s/m]=[rayls]. Airflow resistivity (a) is defined as ΔP/h·v [Pa·s/m²]=[rayls/m], wherein h is the thickness of the sample of composite material 20. The specific airflow resistance of one variation of the composite material may be in a range between 500 and 2000 rayls.

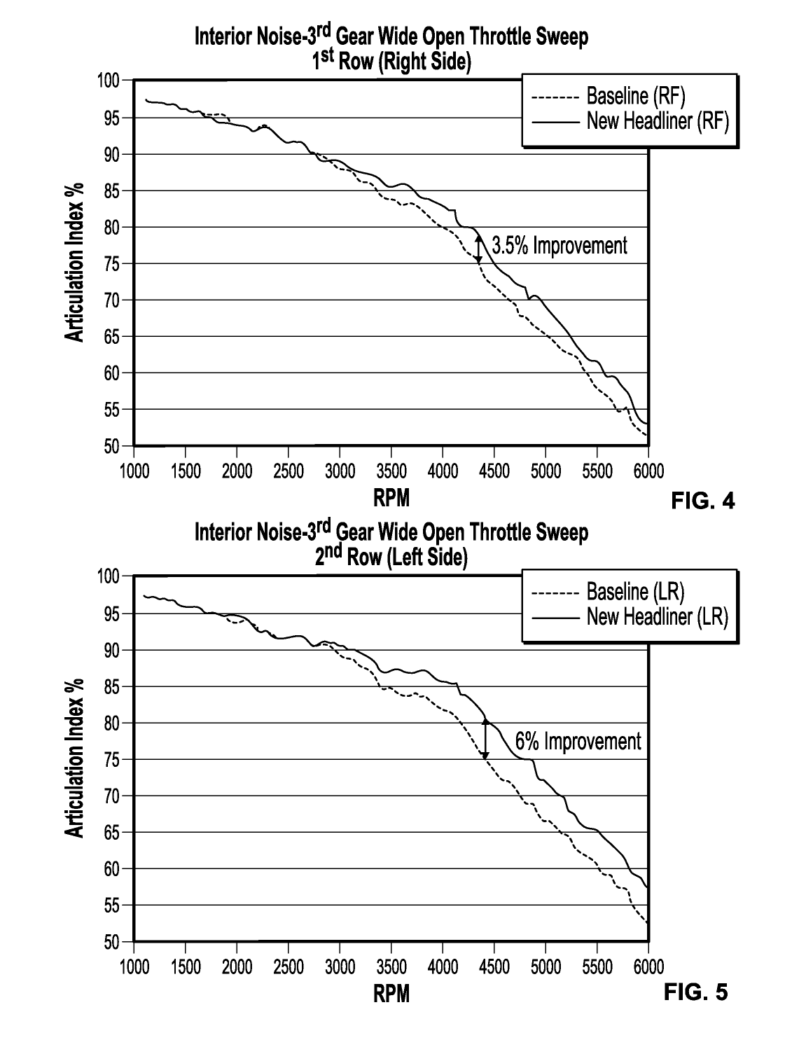

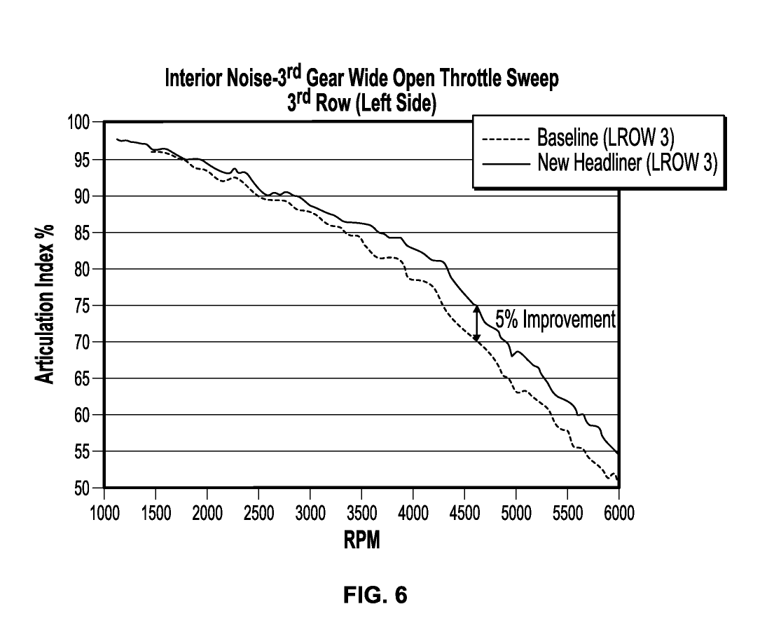

In-vehicle measurement of drive away noise for sound absorption materials may be measured according to GMW 8456 wherein microphones are placed inside the vehicle in the driver's and passenger's head areas. Then, while the vehicle in 3^{rd} gear is accelerated under Wide Open Throttle (WOT) condition from 1000 engine rpm to 6000 engine rpm (run-up sweep). The interior sound pressure levels are recorded during the acceleration. FIG. 4 is a comparison line chart of Articulation Index % for the vehicle in 3^{rd} gear Wide Open Throttle Sweep from 1000 to 6000 engine RPM in the first row (right front passenger's side head position) of one variation of the composite material and one variation of a prior art composite material baseline. FIG. 5 is a comparison line chart of Articulation Index % for the vehicle in 3^{rd} gear Wide Open Throttle Sweep from 1000 to 6000 engine RPM in the second row (left rear passenger's side head position) of one variation of the composite material and one variation of a prior art composite material baseline. FIG. 6 is a comparison line chart of Articulation Index % for the vehicle in 3^{rd} gear Wide Open Throttle Sweep from 1000 to 6000 engine RPM in the third row (third row passenger's side head position) of one variation of the composite material and one variation of a prior art composite material baseline.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a composite material including a finishing, a porous film, a weave, a foam, and a bonding agent, wherein the finishing at least partially overlays the porous film, wherein the porous film at least partially overlays the weave, wherein the weave at least partially overlays the foam, and wherein the porous film includes high density polyethylene.

Variation 2 may include a product as set forth in Variation 1 wherein the film further includes ethylene vinyl acetate.

Variation 3 may include a product as set forth in any of Variations 1-2 wherein the foam includes an open cell foam including polyurethane, polyester, alumina, beryllia, ceria, zirconia, silicide, nitride, boride, carbide, a surfactant, an organic solvent, a fluoroprotein, rubber, polyether, polyethylene, crosslinked polyethylene, latex, neoprene, ethafoam, polystyrene, styrofoam, polyfoam, polyisocyanate, cyanamide, or melamine.

Variation 4 may include a product as set forth in any of Variations 1-3 wherein the weave includes at least one fiber including fiberglass.

Variation 5 may include a product as set forth in any of Variations 1-4 wherein the finishing includes a non-woven fabric.

Variation 6 may include a product as set forth in any of Variations 1-5 wherein the foam further includes at least one tertiary amine.

Variation 7 may include a product as set forth in any of Variations 1-6 wherein the product has a sound absorption coefficient that is at least 0.5 at frequencies of at least 800 Hz.

Variation 8 may include a product as set forth in any of Variations 1-7 wherein the bonding agent includes a resin including at least one of urethane resin, vinylester resin, polyester resin, epoxy resin, phenolic resin, modified phenolic resin, vinyl-bis-phenolic resin, or esther-vinylic resin.

Variation 9 may include a product as set forth in any of Variations 1-8 further including a second weave, a second porous film, and a second finishing, wherein the second finishing at least partially overlays the second film, wherein the second porous film at least partially overlays the second weave, wherein the second weave at least partially overlays the foam on the opposite side of said weave, and wherein the second porous film includes high density polyethylene.

Variation 10 may include a product as set forth in any of Variations 1-9 wherein the second porous film further includes ethylene vinyl acetate.

Variation 11 may include a product as set forth in any of Variations 1-10 wherein the product has a sound absorption coefficient that is at least 0.5 at frequencies of at least 800 Hz.

Variation 12 may include a method including: providing a plurality of components including a finishing, a film, a weave including high density polyethylene, a foam, a bonding agent, and a mold cavity, positioning the finishing in the mold cavity, positioning the bonding agent in contact with the finishing, positioning the film over the finishing, positioning the weave over the film, positioning the foam over the weave, wherein at least one of the plurality of components comprises a curable material, and curing the curable material to form a composite material comprising the plurality of components.

Variation 13 may include a method as set forth in Variation 12 wherein the film further includes ethylene vinyl acetate.

Variation 14 may include a method as set forth in any of Variations 12-13 wherein the film becomes porous.

Variation 15 may include a method as set forth in Variations 12-14 wherein the weave includes at least one fiber including fiberglass.

Variation 16 may include a method as set forth in any of Variations 12-15 wherein the foam includes at least one of polyurethane, polyester, alumina, beryllia, ceria, zirconia, silicide, nitride, boride, carbide, a surfactant, an organic solvent, a fluoroprotein, rubber, polyether, polyethylene, crosslinked polyethylene, latex, neoprene, ethafoam, polystyrene, styrofoam, polyfoam, polyisocyanate, cyanamide, or melamine.

Variation 17 may include a method as set forth in any of Variations 12-16 wherein the foam further includes at least one tertiary amine.

Variation 18 may include a method including: providing a plurality of components including a first finishing, a first film including high density polyethylene, a first weave, a foam, a first bonding agent, a second finishing, a second film including high density polyethylene, a second weave, a second bonding agent and a mold cavity, positioning the first finishing in the mold cavity, positioning the first bonding agent in contact with the first finishing, positioning the first film over the first finishing, positioning the first weave over the first film, positioning the foam over the first weave, positioning the second weave over the foam, positioning the second film over the second weave, positioning the second bonding agent in contact with the second finishing, positioning the second bonding agent and the second finishing over the second film, wherein at least one of the plurality of components comprises a curable material, and curing the curable material to form a composite material comprising the plurality of components.

Variation 19 may include a method as set forth in Variation 18 wherein at least one of the first film or the second film becomes porous.

Variation 20 may include a method as set forth in any of Variations 18-19 wherein at least one of the first film or the second film includes ethylene vinyl acetate.

Variation 21 may include a product as set forth in any of Variations 1-11 wherein the composite material includes a plurality of layers.

Variation 22 may include a product as set forth in any of Variations 1-11 and 21 wherein the foam is at least one of a ballistic foam, a nanofoam, a syntactic foam, an integral skin foam, a solid foam, a liquid foam, a high-expansion foam, an alcohol-resistant foam, a high density foam, or a low density foam.

Variation 23 may include a product as set forth in any of Variations 1-11 and 21-22 wherein the foam further includes at least one of polyurethane, polyester, alumina, beryllia, ceria, zirconia, silicide, nitride, boride, carbide, a surfactant, an organic solvent, a protein foam, Evlon, rubber, Supreem, Rebond, Memory Foam, Polyether, Polyethylene, Crosslinked Polyethylene, Latex, Neoprene, Ethafoam, Polystyrene, Styrofoam™, Polyfoam, Nimbus, or IMPAXX™.

Variation 24 may include a product as set forth in any of Variations 1-11 and 21-23 wherein the foam is high density or low density.

Variation 25 may include a product as set forth in any of Variations 1-11 and 21-24 wherein the foam includes an isocyanate further including at least one of aromatic isocyanates, diphenylmethane diisocyanate (MDI) or toluene diisocyanate (TDI), aliphatic isocyanates, such as hexamethylene diisocyanate (HDI) or isophorone diisocyanate (IPDI).

Variation 26 may include a product as set forth in any of Variations 1-11 and 21-25 wherein the foam further includes a polyol including at least one of polyether polyols or polyester polyols, polypropylene oxide, graft polyols, polycarbonate polyols, polycaprolactone polyols, polybutadiene polyols, polysulfide, natural oil polyols, FEVE fluorinated polyols, dipropylene glycol, glycerine, sorbitol, sucrose, sorbitol, toluenediamine, or Mannich bases.

Variation 27 may include a product as set forth in any of Variations 1-11 and 21-26 wherein the foam contains a chain extender including at least one of ethylene glycol, 1,4-butanediol (1,4-BDO or BDO), 1,6-hexanediol, cyclohexane dimethanol or hydroquinone bis(2-hydroxyethyl) ether (HQEE).

Variation 28 may include a product as set forth in any of Variations 1-11 and 21-27 wherein the foam further contains a surfactant including at least one of polydimethylsiloxane-polyoxyalkylene block copolymers, silicone oils, or nonylphenol ethoxylates.

Variation 29 may include a product as set forth in any of Variations 1-11 and 21-28 wherein the foam has a density of 18 kg/m³.

Variation 30 may include a product as set forth in any of Variations 1-11 and 21-29 wherein the foam has a range of 10 to 20 cells/cm.

Variation 31 may include a product as set forth in any of Variations 1-11 and 21-30 wherein the foam is impregnated with polymeric MDI.

Variation 32 may include a product as set forth in any of Variations 1-11 and 21-31 wherein the foam includes an isocyanate group reactive tertiary amines with a density of 320 g/m².

Variation 33 may include a product as set forth in any of Variations 1-11 and 21-32 wherein the foam has a mass concentration of 18 g/L.

Variation 34 may include a product as set forth in any of Variations 1-11 and 21-33 wherein the weave includes at least one fiber including at least of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomax), microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), basalt, stainless steel, titanium, steel, cast iron, alloy steel, stainless steel, platinum, palladium, aluminum, copper, nickel, iron, lead, tin, cobalt, or bronze.

Variation 35 may include a product as set forth in any of Variations 1-11 and 21-34 wherein weave is manufactured or woven through weaving, knitting, braiding, stitching, plain weaving, and satin weaving in a two dimensional or three dimensional orientation.

Variation 36 may include a product as set forth in any of Variations 1-11 and 21-35 wherein the weave is formed by sheets, continuous mats, or as continuous filaments.

Variation 37 may include a product as set forth in any of Variations 1-11 and 21-36 wherein the weave includes a roving processed on a rolling machine.

Variation 38 may include a product as set forth in any of Variations 1-11 and 21-37 wherein the weave is formed using at least one of a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, or a continuous filament method.

Variation 39 may include a product as set forth in any of Variations 1-11 and 21-38 wherein the weave includes short fiber-reinforced materials or continuous fiber-reinforced materials.

Variation 40 may include a product as set forth in any of Variations 1-11 and 21-39 wherein the weave has a fiber length of between 70 and 100 mm.

Variation 41 may include a product as set forth in any of Variations 1-11 and 21-40 wherein the bonding agent without load may be 30-35% weight.

Variation 42 may include a product as set forth in any of Variations 1-11 and 21-41 wherein the bonding agent with load may be 15-20% by weight.

Variation 43 may include a product as set forth in any of Variations 1-11 and 21-42 wherein the film includes a high density or low density polymer.

Variation 44 may include a product as set forth in any of Variations 1-11 and 21-43 wherein the film includes a polymer including, lyocell rayon, modal rayon, rayon, glass, silica, carbon, basalt, metallic, acrylic, aramid, microfiber, modacrylic, nylon, olefin, polyester, spandex, vinylon, vinyon, polyvinyl chloride (PVC), bioplastic, zylon, saran, rubber, vulcanized rubber, urea-formaldehyde, melamine, polyimide, cyanate ester, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), acrylic (PMMA), polyethylene (PE), PEO, PET, polypropylene (PP), PEN, PPS, Teflon (PTFE), or polystyrene (PS).

Variation 45 may include a product as set forth in any of Variations 1-11 and 21-44 wherein the film is formed using at least one of a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, continuous filament, extrusion, continuous extrusion, cast, calendar rolls, skiving, solution deposition, lamination, or physical vapor deposition.

Variation 46 may include a product as set forth in any of Variations 1-11 and 21-45 wherein the finishing includes a plurality of fibers including at least one of alpaca, angora, byssus, camel hair, cashmere, catgut, chiengora, guanaco, llama, mohair, pashmina, qiviut, rabbit, silk, sinew, spider silk, wool, vicuna, yak, abaca′, bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, aramid (including Twaron, Kevlar, Technora, Nomax), microfiber, modacrylic, nylon, olefin, polyester, polyurethane, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), basalt, aluminum, felt, polyethylene (PE), PEO, PET, polypropylene (PP), PEN, PPS, Teflon (PTFE), polystyrene (PS), poly vinyl chloride (PVC), stainless steel, titanium, steel, cast iron, alloy steel, stainless steel, platinum, palladium, aluminum, copper, nickel, iron, lead, tin, cobalt, or bronze.

Variation 47 may include a product as set forth in any of Variations 1-11 and 21-46 wherein the finishing is formed by sheets, continuous mats, or as continuous filaments.

Variation 48 may include a product as set forth in any of Variations 1-11 and 21-47 wherein the finishing is manufactured or woven through weaving, knitting, braiding, stitching, plain weaving, and satin weaving in a two dimensional or three dimensional orientation.

Variation 49 may include a product as set forth in any of Variations 1-11 and 21-48 wherein the finishing is formed using at least one of a hand lay-up operation, a spray lay-up operation, a pultrusion operation, a chopped strand mat, vacuum bag moulding, pressure bag moulding, autoclave moulding, polymeric liquid composite moulding, resin transfer moulding, vacuum assisted resin transfer moulding, bladder moulding, compression moulding, mandrel wrapping, wet layup, chopper gun, filament winding, melting, staple fiber, or a continuous filament method.

Variation 50 may include a product as set forth in any of Variations 1-11 and 21-49 wherein the finishing includes short-fiber reinforced materials or continuous fiber-reinforced materials

Variation 51 may include a product as set forth in any of Variations 1-11 and 21-50 wherein the finishing includes 100% polyester made using a tear or needled process.

Variation 52 may include a product as set forth in any of Variations 1-11 and 21-51 wherein the finishing has a mass dispersion in the range of 150 g/m to 250 g/m coupled or not to a polyester foam.

Variation 53 may include a product as set forth in any of Variations 1-11 and 21-52 wherein the finishing has a density of 45 g/m².

Variation 54 may include a product as set forth in any of Variations 1-11 and 21-53 wherein the bonding agent is reactive.

Variation 55 may include a product as set forth in any of Variations 1-11 and 21-54 wherein the finishing includes 100% polyester made using a tear or needled process.

Variation 56 may include a method as set forth in any of Variations 12-20 wherein the foam 22, weave 24, film 26, or finishing 28, or any combination are manufactured or woven through weaving, knitting, braiding, stitching, plain weaving, or satin weaving in any degree.

Variation 57 may include a method as set forth in any of Variations 12-20 and 56 wherein at least one of the foam 22, weave 24, film 26, finishing 28 is bundled prior to manufacture.

Variation 58 may include a method as set forth in any of Variations 12-20, and 56-57 wherein the film is preimpregnated, coated, saturated, positioned in a layer, or otherwise contacted with the bonding agent.

Variation 59 may include a method as set forth in any of Variations 12-20 and 56-58 wherein the weave is preimpregnated, coated, saturated, positioned in a layer, or otherwise contacted with the bonding agent 30

Variation 60 may include a method as set forth in any of Variations 12-20, and 56-59 wherein foam is preimpregnated, coated, saturated, positioned in a layer, or otherwise contacted with the bonding agent.

Variation 61 may include a method as set forth in any of Variations 12-20, and 56-60 wherein the film is positioned to at least partially overlay, overlay, partially surround, or fully surround the finishing.

Variation 62 may include a method as set forth in any of Variations 12-20 and 56-61 wherein the weave is positioned to at least partially overlay, overlay, partially surround, or fully surround the film.

Variation 63 may include a method as set forth in any of Variations 12-20, and 56-62 wherein foam is positioned to at least partially overlay, overlay, partially surround, or fully surround the weave.

Variation 61 may include a method as set forth in any of Variations 12-20, and 56-63 wherein the composite material is formed using at least one of hand lay-up operation, a spray lay-up operation, a pultrusion operation, a chopped strand mat, vacuum bag moulding, pressure bag moulding, autoclave moulding, resin transfer moulding, injection moulding, polymeric liquid composite moulding, vacuum assisted resin transfer moulding, bladder moulding, compression moulding, mandrel wrapping, face sheet rolling, wet layup, chopper gun, or filament winding.

Variation 62 may include a product as set forth in any of Variations 1-11 and 21-54 wherein the composite material has a specific airflow resistance of between 500 and 2000 rayls.

Variation 63 may include a product as set forth in any of Variations 8-11 and 21-54 and 62 wherein the second weave comprises at least one fiber comprising fiberglass.

Variation 64 may include a product as set forth in any of Variations 8-11 and 21-54 and 62-63 wherein the second finishing comprises a non-woven fabric.

The above description of select examples within the scope of the invention is merely exemplary in nature and, thus, variations or variants thereof are not to be regarded as a departure from the spirit and scope of the invention.

What is claimed is:

1. A product comprising:
a composite material comprising a finishing, a porous film, a weave, a foam, and a bonding agent, wherein the finishing at least partially overlays the porous film, wherein the porous film at least partially overlays the weave, wherein the weave at least partially overlays the foam, and wherein the porous film comprises high density polyethylene.

2. A product as described in claim 1 wherein the porous film further comprises ethylene vinyl acetate.

3. A product as described in claim 1 wherein the foam comprises an open celled foam comprising at least one of polyurethane, polyester, alumina, beryllia, ceria, zirconia, silicide, nitride, boride, carbide, a surfactant, an organic solvent, a fluoroprotein, rubber, polyether, polyethylene, crosslinked polyethylene, latex, neoprene, ethafoam, polystyrene, styrofoam, polyfoam, polyisocyanate, cyanamide, or melamine.

4. A product as described in claim 1 wherein the weave comprises at least one fiber comprising fiberglass.

5. A product as described in claim 1 wherein the finishing comprises a non-woven fabric.

6. A product as described in claim 1 wherein the foam further comprises at least one tertiary amine.

7. A product of claim 1 wherein the bonding agent comprises a resin comprising at least one of urethane resin, vinylester resin, polyester resin, epoxy resin, phenolic resin, modified phenolic resin, vinyl-bis-phenolic resin, or esther-vinylic resin.

8. A product as described in claim 1 further comprising a second weave, a second porous film, and a second finishing, wherein the second finishing at least partially overlays the second film, wherein the second film at least partially overlays the second weave, wherein the second weave at least partially overlays the foam on the opposite side of said weave, and wherein the second porous film comprises high density polyethylene.

9. A product as described in claim 8 wherein the second porous film further comprises ethylene vinyl acetate.

10. A product as described in claim 8 wherein the second weave comprises at least one fiber comprising fiberglass.

11. A product as described in claim 8 wherein the second finishing comprises a non-woven fabric.

12. A method comprising:
providing a plurality of components comprising a finishing, a film, a weave comprising high density polyethylene, a foam, a bonding agent, and a mold cavity,
positioning the finishing in the mold cavity,
positioning the bonding agent in contact with the finishing,
positioning the film over the finishing,
positioning the weave over the film,
positioning the foam over the weave, wherein at least one of the plurality of components comprises a curable material, and
curing the curable material to form a composite material comprising the plurality of components.

13. A method as described in claim 12 wherein the film further comprises ethylene vinyl acetate.

14. A method as described in claim 12 wherein the film becomes porous.

15. A method as described in claim 12 wherein the weave comprises at least one fiber comprising fiberglass.

16. A method as described in claim 12 wherein the foam comprises at least one of polyurethane, polyester, alumina, beryllia, ceria, zirconia, silicide, nitride, boride, carbide, a surfactant, an organic solvent, a fluoroprotein, rubber, polyether, polyethylene, crosslinked polyethylene, latex, neoprene, ethafoam, polystyrene, styrofoam, polyfoam, polyisocyanate, cyanamide, or melamine.

17. A method as described in claim 16 wherein the foam further comprises at least one tertiary amine.

18. A method comprising:
providing a first finishing, a first film comprising high density polyethylene, a first weave, a foam, a first bonding agent, a second finishing, a second film comprising high density polyethylene, a second weave, a second bonding agent and a mold cavity,
positioning the first finishing in the mold cavity,
positioning the first bonding agent in contact with the first finishing,
positioning the first film over the first finishing,
positioning the first weave over the first film,
positioning the foam over the first weave,
positioning the second weave over the foam,
positioning the second film over the second weave,
positioning the second bonding agent in contact with the second finishing,
positioning the second bonding agent and the second finishing over the second film, wherein at least one of the plurality of components comprises a curable material, and
curing the curable material to form a composite material comprising the plurality of components.

19. A method as described in claim 18 wherein at least one of the first film or the second film becomes porous.

20. A method as described in claim 18 wherein at least one of the first film or the second film comprises ethylene vinyl acetate.
